(19) United States
(12) Patent Application Publication
(10) Pub. No.: US 2005/0246734 A1
(43) Pub. Date: Nov. 3, 2005

(54) Method and apparatus for obtaining research data over a communications network

(76) Inventors: Arthur J. Kover, Clintin, CT (US); Owen Davis, Flemington, NJ (US); Richard R. Berke, Doylestown, PA (US)

Correspondence Address: Steven S. Payne, Suite 1005, 1101 17th Street N.W., Washington, DC, 20036, US

(21) Appl. No.: 10/834,089

(22) Filed: Apr. 29, 2004

(51) Int. Cl. H04N 7/173; H04N 7/025; H04H 9/00; H04N 7/16

(52) U.S. Cl. 725/24; 725/112; 725/113; 725/13; 725/32

(57) ABSTRACT

A method and apparatus for obtaining research data over a communications system is disclosed. A presentation is presented at least once to a participant using a web site. The participant's reactions are recorded for a different category of reactions to be measured each time the advertisement is displayed. A presentation can be a visual and/or audio presentation such as an advertisement with static or moving images, marketing information, brochures, sales information, live or recordedspeeches, television programs, movies, videos, music, computer graphics, computer games or any other media which can be projected audioly and/or visually over a communications network.

### FIELD OF THE INVENTION

The present invention relates generally to obtaining comprehensive research data on the effectiveness of a presentation such as an advertisement. More particularly, the present invention relates to a method and apparatus for obtaining web-based research data, for example advertising research data, on the effectiveness of a presentation over a communications network such as the Internet.

### BACKGROUND OF THE INVENTION

The objective of advertising research seems rather straightforward, predict how an advertisement will be perceived in the real world. However, it is not really that easy, as the reactions to advertisements are often very complex and not completely understood.

There are several key questions which need to be addressed during the measurement process. First, it needs to be determined whether the advertising breaks through the clutter of other advertising. The elements in the advertising which attract attention need to be determined. It also needs to be determined what the advertisement communicates to the viewers. Finally, it needs to be determined what is persuasive and believable about the advertisement.

While the total measurement process is more complex, factors one and three, listed above, are two of the more difficult phases in the research process. Obviously, advertising can not convey important messages if the viewer does not see or hear the communication. Thus, it is crucial for an advertisement to make a quick and lasting impression on the viewer's first and potentially only viewing of the advertisement.

One known method for measuring what is being communicated to viewers is the so-called “eye tracking” method. This method is very expensive and involves intricate equipment. The eye tracking method assesses what the viewer sees by using a special camera that tracks the motion of a person's eyes as he or she looks at an advertisement on paper or on a monitor. The camera captures critical information such as what a person sees first, what element has the greatest impact on the viewer, what words the person sees and whether the brand's logo is identified.

While the eye-tracking method can determine what the person sees, the eye-tracking method can not determine what the person actually thinks of the advertisement both in whole and in part. One method for determining a persons thoughts on an advertisement is to use a rotating knob which the person turns one way or the other to indicate their real-time reactions to an advertisement being displayed. This process can be used to test the impact, communication and persuasion of the advertisement. One problem with this method and the eye-tracking method is that both methods require people to be tested from a central fixed location. These methods are expensive to conduct and constrained by the number of people who visit the fixed location.

Accordingly, it is desirable to provide a method for obtaining advertising research data without the need for complicated and cumbersome equipment and that can be obtained from a multitude of locations and participants. Furthermore, it is an objective of the invention to measure reaction data for a multitude of different types of presentations which can be audioly and/or visually over a communication network such as the Internet.

### SUMMARY OF THE INVENTION

It is therefore a feature and advantage of the present invention to provide a method and apparatus for obtaining low cost research data using a communications system such as the Internet. The present invention combines a point-and-click feature and the interactivity of the Internet to capture a persons real-time impressions and thoughts of a presentation.

In accordance with one embodiment of the present invention, a method and apparatus for obtaining research data over a communications system is disclosed. A presentation is presented at least once to a participant using a web site. The participant's reactions are recorded for a different category of reactions to be measured each time the advertisement is displayed. A presentation can be a visual and/or audio presentation such as an advertisement with static or moving images, marketing information, brochures, sales information, live or recordedspeeches, television programs, movies, videos, music, computer graphics, computer games or any other media which can be projected audioly and/or visually over a communication network.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The invention will now be described, by way of example, with reference to the accompanying drawings, wherein:

FIG. 1 illustrates a computer system according to one embodiment of the invention;

FIG. 2 illustrates a screen shot according to one embodiment of the invention;

FIG. 3 illustrates a flow chart showing the operation of the computer system according to one embodiment of the invention;

FIG. 4 illustrates an instruction screen according to one embodiment of the invention;

FIGS. 5-7 illustrate screen shots according to one embodiment of the invention; and

FIG. 8 illustrates Cartesian graphs of polled measurements according to one embodiment of the invention.

### DETAILED DESCRIPTION OF PREFERRED EMBODIMENTS OF THE INVENTION

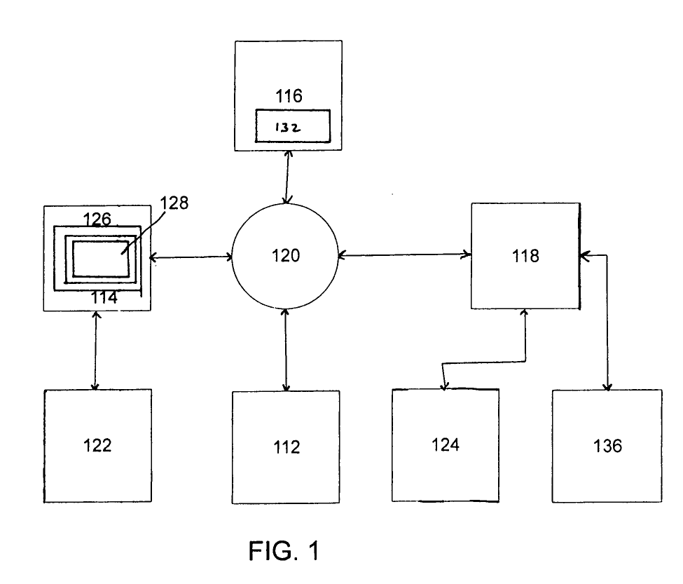

FIG. 1 illustrates an exemplary system 100 for obtaining web-based research data over a communications network, such as the Internet, according to one embodiment of the invention. As described more fully below, the system 100 allows a multitude of participants to view presentations such as an advertisement with static or moving images, marketing information, brochures, sales information, live or recorded speeches, television programs, movies, videos, music, computer graphics, computer games or any other media which can be projected audioly and/or visually over the Internet and record their real-time reactions and thoughts about the presentation through a series of requests and questions based on their reactions.

Using the interactivity of the Internet, the present invention can provide precise, effective web-based research data on presentations, which was previously only possible using expensive and cumbersome machines. The present invention can provide powerful insights into why, for example, advertising does and doesn't work. The present invention can enrich knowledge, and speed and enhance the decision making process within the framework of qualitative research without the expense and problems associated with other methods. An important aspect of this invention is that this method of testing realizes that emotion and rationality are both involved in the person's response. When a person sees a presentation, the person may pay attention to a certain item or object, but the person will filter the message based on their personal experiences. In other words, people are pre-disposed to filter information they receive using their existing mental structure. The results of the testing method of the present invention show which specific elements of communication, even ones not thought to be important by the originator of the presentation, are important to the people who view the presentation.

According to one embodiment of the invention, the research participant is asked to view an advertisement over a network such as the Internet and record their reactions to the advertisement using a mouse or keyboard controls. The participant can then be asked a series of questions regarding the advertisement based at least partially on their recorded reactions. It will be understood by those skilled in the art that the advertisement can be a video, slide show, animation, flash animation, or any other type of advertisement that changes over time.

The exemplary system 100 includes a website owner 112, a web server 114, one or more website participants 116, and a reporting server 118 coupled to one another using a network 120. It will be understood by those skilled in the art that the network may be any suitable local area network (LAN), metropolitan area network (MAN), wide area network (WAN), a global communications network such as the Internet, or any other suitable network. Although the owner 112, the server 114, the participants 116, and the server 118 are described as coupled using a single network 120, the present invention contemplates multiple networks 120 of the same type or different types to couple these components together, according to particular needs. The owner 112 and the participants 116 may each be autonomous computer systems or may receive appropriate input from one or more associated persons. The servers 114 and 118 may include software operating on one or more computer systems 122 and 124, respectively, at one or more locations. The owner 112, the server 114 and the server 118 may operate on at least one shared computer system. The computer systems associated with the owner 112, the participants 116, the servers 114 and 118 include input devices, output devices, processors, memories, and other components suitable for the features and operations described below.

The web server 114 hosts or otherwise supports at least one website 126 including one or more pages 128. Although the pages 128 are described primarily as web pages 128 associated with a typical website 126, the present invention contemplates measuring and reporting user reactions to video, animation, flash animation, slide show or any other type of moving advertisements. Moreover, although a single website 126 for a single owner 112 is described in detail, the server 114 may support one or more websites 126 for each of multiple owners 112.

In general, using an associated web browser or other software component, the participant 116 provides a uniform resource locator (URL) or other electronic address to establish a connection to the server 114 and access a particular page 128 associated with the website 126. The server 114 communicates the requested page 128 to the participant 116 using the network 120, the participant 116 receives the page 128, and the participant 116 views or otherwise processes the page 128 according to the participant's particular needs. The participant 116 will typically provide one or more additional URLs during a single browser session to access additional pages 128 associated with the website 126, navigating through the topography of the website 126 according to particular needs. Multiple participants 116 may access a single page 128 substantially simultaneously. The present invention contemplates one or more website participants 116 accessing one or more pages 128 of the website 126 in a suitable manner during one or more browser sessions.

According to one embodiment of the invention, the advertisement is shown to the participant and the participant uses a mouse or various keys on a keyboard or some other input device to move an indication marker on a meter from one side to the other side depending on the participant's reactions to the advertisement. The participant's responses are collected, for example in a data array, and then sent via the network 120 to the server 118 and stored in a database 136. Software in the server and/or the associated computer 124 analyzes and interprets the received data as will be described in more detail below.

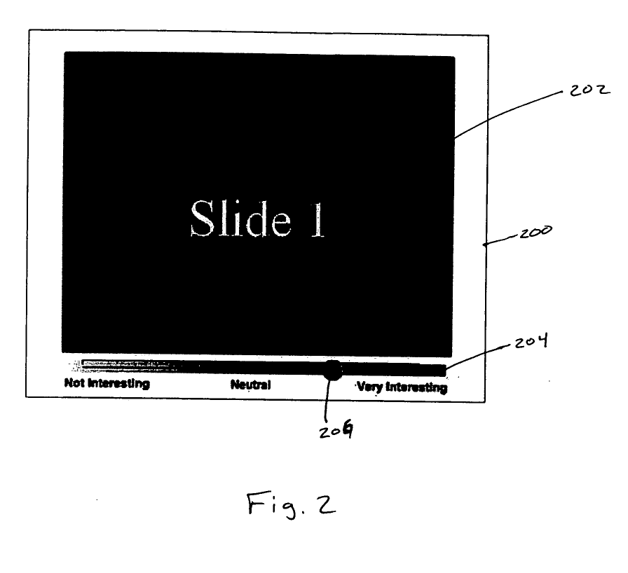

The invention can be employed via the HTTP protocol through a participant's web browser. Flash animations can be embedded within the window providing a dial-emulation facility as well as visual and audio components. Dial-emulation consists of a vertical or horizontal bar. For example, the far left stop of the meter can indicate the most negative response and the far right stop can indicate the most positive response rating. As illustrated in FIG. 2, a screen 200 is displayed on the participants computer screen. The screen 200 has an image section 202 for displaying the advertisement and a meter 204. The meter 204 has an indication marker for indicating the participant's reactions. In this illustrative example, the meter is a horizontal bar below the image section 202. It will be understood by those skilled in the art that the meter can be a horizontal or vertical bar (or some other shape) and can appear anywhere on the screen 200.

The user can manipulate the indication marker 206 utilizing his or her mouse as the input device. Coincidentally, moving the mouse left of its relative position will move the indication maker 206 to the left and vice versa. Alternatively, the participant can use keys on a keyboard or any other input device to manipulate the indication marker 206.

In this embodiment, two basic measurements will be described. These measurements include the level of interest in the advertisement and the believability of the advertisement. The measurements are collected back-to back per advertisement concept. The order of the measurement collection can rotate in order to remove any potential biases. It will be understood by those skilled in the art that any number of measurements can be made on the advertisement concept to gage different reactions and emotions and the invention is not limited thereto. For exa,ple, the level of a participant's like or dislike of the advertisement can also be measured.

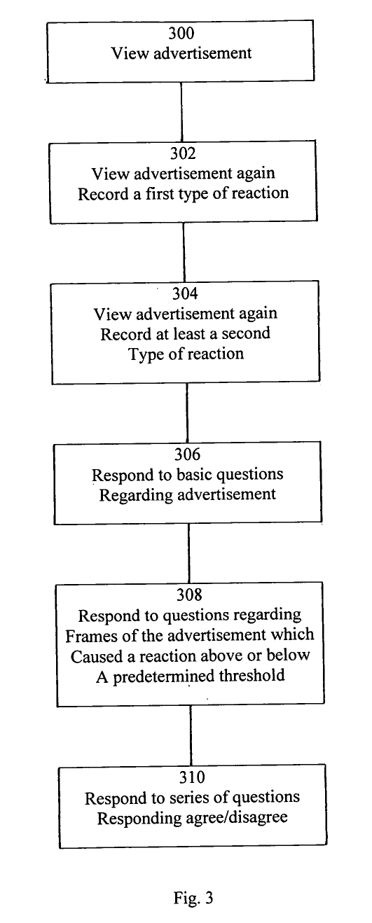

A method for obtaining web-based advertising research data over the Internet according to one embodiment of the invention will now be described with reference to FIG. 3. It will be understood by those skilled in the art that any number of steps illustrated in FIG. 3 can be skipped or the order of the steps can be changed without departing from the scope or spirit of the invention. When a participant 116 enters the website 126 and agrees to participate in research survey, access to a plurality of web pages and other tools are downloaded to the participant's computer 116. One such tool 132 includes data gathering functions that record all of the data entered by the participant 116 during the survey.

In the exemplary embodiment described below, the participant 116 is asked to progress through steps 300-310 for each advertisement in the survey. It will be understood by those skilled in the art that the participant 116 may be presented with all of the steps sequentially for one advertisement before being asked to repeat the process for another advertisement. It will be understood that different embodiments of the invention can use some or all of the steps in different order without departing from the spirit or scope of the invention.

In step 300, the participant 116 is asked to view an advertisement. In this illustrative example, the advertisement is a slide show made up of a plurality of slides, wherein each slide is displayed for a predetermined period of time. The slide show can be accompanied by an audio portion for the visual advertisement.

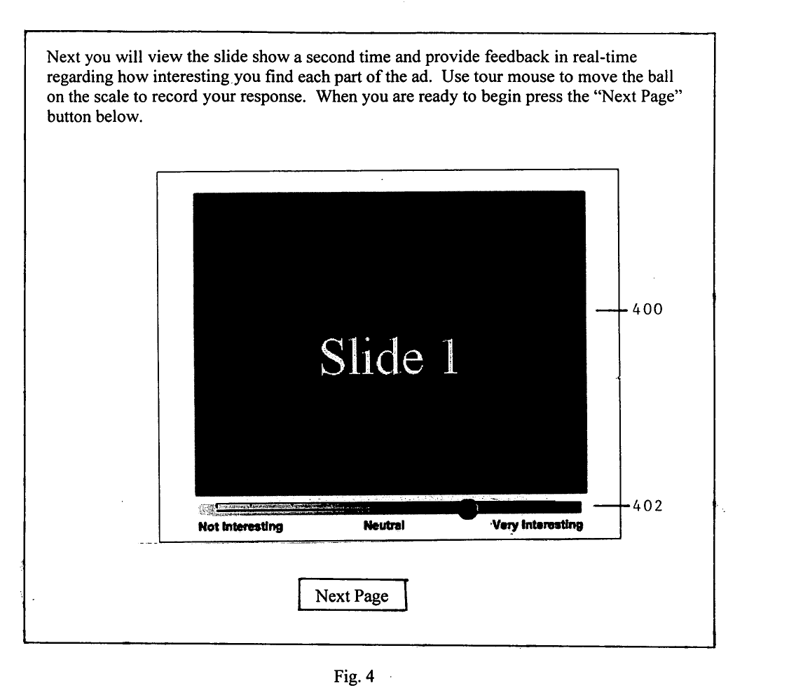

After watching the slide show, an instruction screen 400, such as the one illustrated in FIG. 4, can be displayed with instructions on how to operate the meter 402. In addition, the participant 116 is informed of the type of reaction that the meter 402 will be monitoring. In this example, the first reaction is the participant's interest in the advertisement. When the participant 116 selects the “next page” icon, the advertisement is shown a second time in step 302.

At the start of the slide show, the indication marker on the meter 402 starts in a neutral position. As the slide show progresses, the participant 116 moves their mouse from left to right to move the indication marker from left to right to indicate the appropriate measurement. According to one embodiment of the invention, data is collected from the first measurable second to the last second of the advertisement in intervals of, for example, one second. Interest data is collected numerically on a scale of zero to one hundred, with zero indicating the least amount of interest but the invention is not limited thereto.

At the end of the advertisement, an instruction screen is displayed for the participant 116 to indicate the next reaction to be measured. In this illustrative example, the second reaction to be measured is believability. In step 304, the advertisement is shown a third time and the participant 116 indicates their reactions by moving their mouse accordingly. Believability data is collected numerically on a scale of −50 to 50 with −50 indicating the least amount of believability but the invention is not limited thereto. As mentioned above, the participant 116 can be asked to indicate their reactions to any number of different categories.

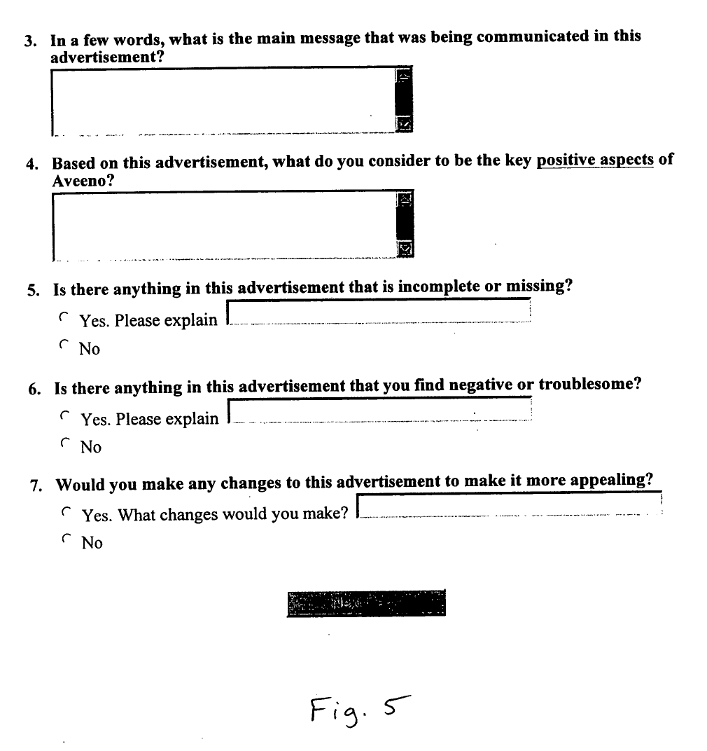

After viewing the advertisement for all of the different categories of reactions to be measured, the participant 116 can then be asked a series of questions regarding the advertisement in step 306. As illustrated in FIG. 5, the questions can be “In a few words, what is the main message that was being communicated in this advertisement”, “Based on this advertisement, what do you consider to be a key positive aspects of the product”, “Is there anything in this advertisement that is incomplete or missing”, “Is there anything in this advertisement that you find negative or troublesome”, “Would you make any changes to this advertisement to make it more appealing” but the invention is not limited thereto. The participant 116 uses their keyboard and mouse to answer the questions.

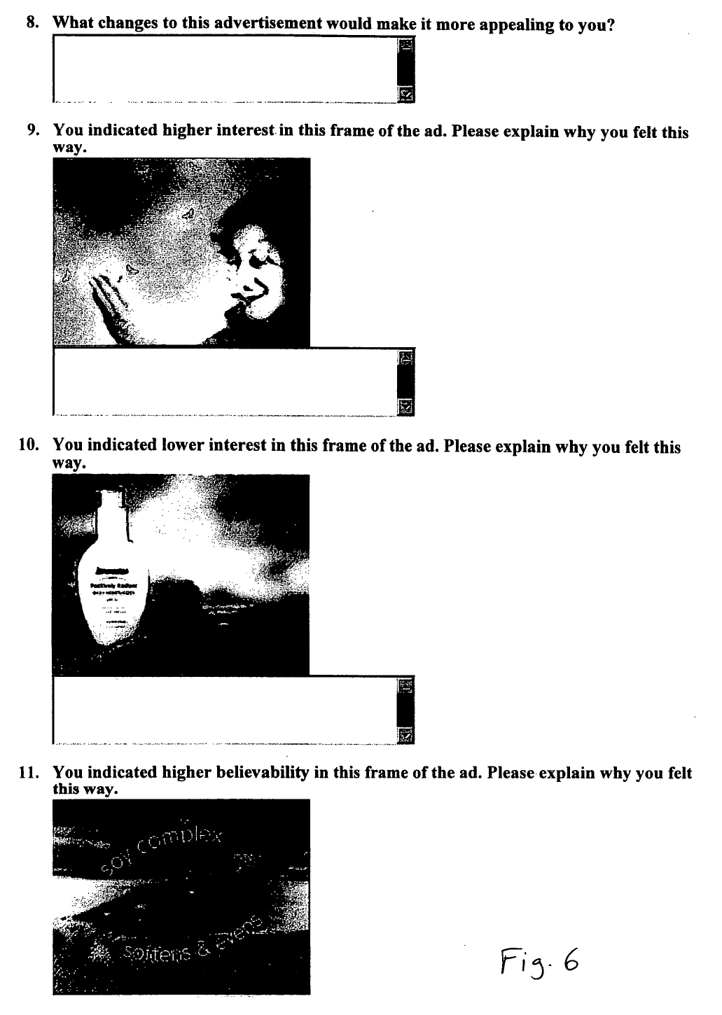

The participant 116 can also be asked specific questions regarding their measured reactions in step 308. For example, the slides with the highest and/or lowest recorded measurements for each category of reaction can be displayed, as illustrated in FIG. 6. Alternatively the participant 116 could be shown all slides which receive a measurement above and/or below various threshold values. The participant 116 can be asked why these frames invoked such extremes in the participant's reactions.

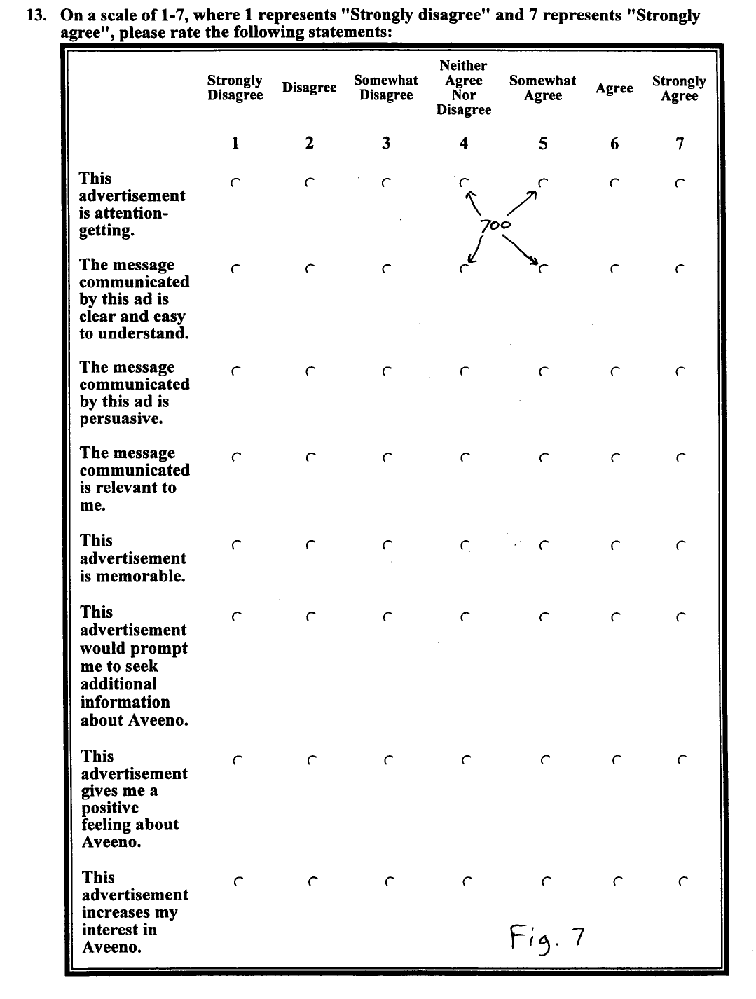

In this embodiment of the invention, the participant 116 is then shown a screen on which at least one statement is presented as illustrated in FIG. 7. The participant 116 is then asked to indicate their level of agreement/disagreement with the statements by marking the appropriate circle 700 in step 310. For example, the participant 116 can be asked whether the advertisement was attention getting, persuasive, memorable, etc., but the invention is not limited thereto.

As mentioned above, the data collection tool 132 records all of the information entered by the participant 116 and sends the collected data to the server 118 via the network 120. It will be understood by those skilled in the art that a variety of different methods and devices can be used to extract the data from the user and the invention is not limited thereto. The collected data is then stored in the database 136 for later use by the computer system 124. The collected data can be analyzed and displayed in a variety of different ways depending on the needs of the owner 112 and the invention is not limited to the displays mentioned below.

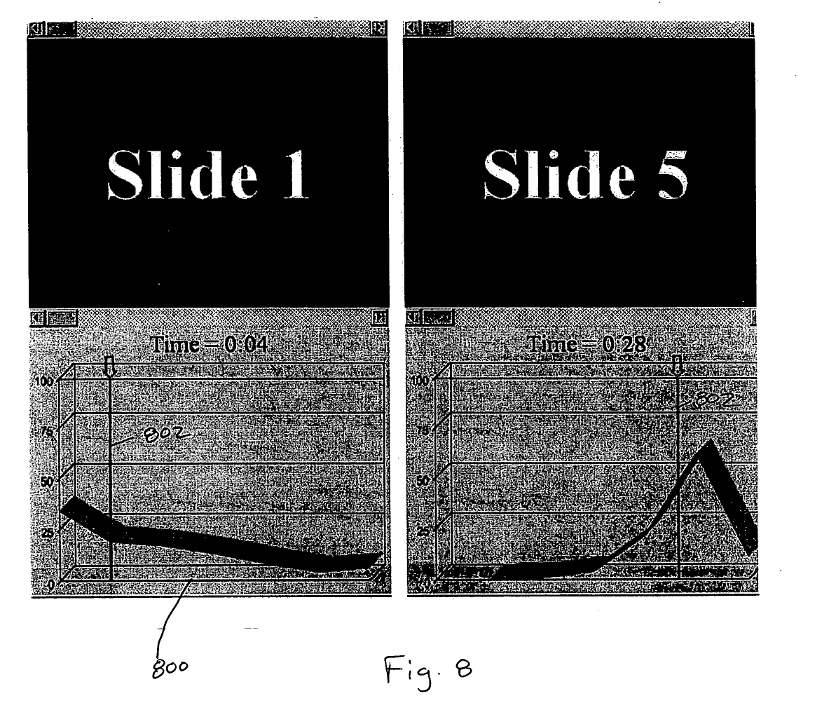

As illustrated in FIG. 8, the results for each participant or a plurality of participants can be displayed in chart form. The viewer of the report will watch the advertisement along with the audio voice-over. A Cartesian graph 800 is displayed beneath the advertisement and represents the polled measurements from either a single participant or an average from a group of participants. As the advertisement progresses, a vertical line 802 will move from left to right to indicate the advertisement's chronological position relative to the graph.

As mentioned above, the system 100 can be used to collect research data on a wide variety of presentations such as an advertisement with static or moving images, marketing information, brochures, sales information, live or recorded speeches, television programs, movies, videos, music, computer graphics, computer games or any other media which can be projected audioly and/or visually over a communication system. For example, the system 100 can be used to measure a participant's reaction to a live or recorded speech. The participant 116 can be asked to view the speech over the communication network 120 and record a first type of reaction in the manner described above. A copy of the live speech or the taped speech can then replayed any number of times to allow the participant to record any number of different types of reactions. Furthermore, the participant 116 can be asked to view television programs, pilot programs, movies, videos, etc., at least once wherein the participant 116 records different types of reactions each time the program is shown. In addition, research data on audion only presentations can also be obtained by playing the audio presentation over the network 120 while the participant records their reactions using the meter 204 as described above.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A method for obtaining research data over a communications system, comprising the steps of:
presenting a presentation at least once to a participant using a web site;
recording the participant's reactions to a different category of reactions to be measured each time the presentation is presented.

2. The method according to claim 1, wherein the presentation is from the group comprising an advertisement with static or moving images, marketing information, brochures, sales information, live or recorded speeches, television programs, movies, videos, music, computer graphics, computer games.

3. The method according to claim 2, wherein the presentation is an advertisement with moving images.

4. The method according to claim 1, further comprising the step of:
posing at least one question to said at least one user based on said collected participant reaction data.

5. The method according to claim 4, wherein a portion of the presentation which received the most favorable reaction is presented and at least one question is posed to the participant regarding the presented portion.

6. The method according to claim 4, wherein a portion of the presentation which received the most negative reaction is presented and at least one question is posed to the participant regarding the presented portion.

7. The method according to claim 5, wherein all portions of the presentation which received a favorable reaction above a predetermined threshold are presented.

8. The method according to claim 6, wherein all portions of the presentation which received a negative reaction below a predetermined threshold are presented.

9. The method according to claim 3, wherein said moving advertisement is from a group of advertisements comprising video, slide show, flash animation and animation.

10. The method according to claim 1, wherein said categories of reactions comprises one of the group of interest, believability, like and dislike.

11. The method according to claim 1, further comprising the step of:
displaying the presentation to the participant for a first time without asking the participant to record their reactions.

12. The method according to claim 1, further comprising the steps of:
analyzing collected reactions;
displaying graphs illustrating at least one participant's reactions for a single category of recorded reactions over the length of the presentation.

13. The method according to claim 1, wherein the participant's reactions are recorded at the end of each predetermined time intervals.

14. The method according to claim 13, wherein the predetermined time interval is one second.

15. An apparatus for obtaining research data over a communications system, comprising:
means for presenting a presentation at least once to a participant using a web site;
means for recording the participant's reactions to a different category of reactions to be measured each time the presentation is presented.

16. The apparatus according to claim 15, wherein the presentation is from the group comprising an advertisement with static or moving images, marketing information, brochures, sales information, live or recorded speeches, television programs, movies, videos, music, computer graphics, computer games.

17. The apparatus according to claim 15, further comprising:
means for posing at least one question to said at least one user based on said collected user reaction data.

18. The apparatus according to claim 17, wherein a portion of the presentation which received the most favorable reaction is presented and at least one question is posed to the participant regarding the presented portion.

19. The apparatus according to claim 17, wherein a portion of the presentation which received the most negative reaction is presented and at least one question is posed to the participant regarding the presented portion.

20. The apparatus according to claim 18, wherein all portions of the presentation which received a favorable reaction above a predetermined threshold are presented.

21. The apparatus according to claim 19, wherein all portions of the presentation which received a negative reaction below a predetermined threshold are presented.

22. The apparatus according to claim 16, wherein said presentation is one of a group of moving advertisements comprising video, slide show, flash animation and animation.

23. The apparatus according to claim 15, wherein said categories of reactions comprises one of the group of interest, believability, like and dislike.

24. The apparatus according to claim 15, further comprising:
means for presenting the presenation to the participant for a first time without asking the participant to record their reactions.

25. The apparatus according to claim 15, further comprising:
means for analyzing collected reactions;
means for displaying graphs illustrating at least one participant's reactions for a single category of recorded reactions over the length of the presenatation.

26. The apparatus according to claim 15, wherein the participant's reactions are recorded at the end of each predetermined time intervals.

27. The apparatus according to claim 26, wherein the predetermined time interval is one second.
